(19) United States
(12) Patent Application Publication
(10) Pub. No.: US 2024/0380254 A1
(43) Pub. Date: Nov. 14, 2024

(54) WIRELESS POWER TRANSMITTER CIRCUIT CAPABLE OF DETECTING MISALIGNMENT AND CONTROL CIRCUIT AND METHOD THEREOF

(71) Applicant: Richtek Technology Corporation, Zhubei City (TW)

(72) Inventors: Li-Ting Tsai, Hsinchu (TW); Fu-Chi Lin, Hsinchu (TW)

(21) Appl. No.: 18/468,713

(22) Filed: Sep. 17, 2023

(30) Foreign Application Priority Data
May 10, 2023 (TW) 112117270

(51) Int. Cl. H02J 50/90; H02J 50/12; H02J 50/80

(52) U.S. Cl. CPC H02J 50/90; H02J 50/12; H02J 50/80

(57) ABSTRACT

A wireless power transmitter circuit includes a power stage circuit including switches coupled to a resonant transmitter circuit; and a transmission control circuit controlling the power stage circuit and including: a modulation circuit generating a PWM control signal during a power supply procedure, to control the switches to convert a DC power and generate a wireless transmission power at the resonant transmitter circuit, thereby supplying the wireless power to a corresponding wireless power receiver circuit; a storage unit storing an authentication code-threshold database; and a communication circuit receiving an authentication code and a signal intensity value transmitted by the wireless power receiver circuit, to read an alignment intensity threshold corresponding to the authentication code from the storage unit, and to compare the signal intensity value with the alignment intensity threshold during a groping procedure to determine whether the wireless power transmitter circuit is aligned with the wireless power receiver circuit.

### CROSS REFERENCE

The present invention claims priority to TW 112117270 filed on May 10, 2023.

### BACKGROUND OF THE INVENTION

### Field of Invention

The present invention relates to a wireless power transmitter circuit; particularly, it relates to such wireless power transmitter circuit, a transmission control circuit of such wireless power transmitter circuit and a transmission control method of such wireless power transmitter circuit, wherein the present invention has capacity to not only detect unwanted misalignment occurring between the wireless power transmitter circuit and a wireless power receiver circuit, but also to instruct an user to adjust a position of the wireless power transmitter circuit and a position of the wireless power receiver circuit, hence executing alignment between the wireless power transmitter circuit and the wireless power receiver circuit.

### Description of Related Art

Please refer to FIG. 1, which shows a prior art characteristic curve depicting a signal intensity of a winding at a wireless power receiver end against an alignment offset between a winding at a wireless power transmitter end and the winding at the wireless power receiver end. For the person skilled in this art, it is imperative whether the winding at the wireless power transmitter end is aligned with the winding at the wireless power receiver end. If the winding at the wireless power transmitter end is not aligned with the winding at the wireless power receiver end, an offset occurring between the wireless power transmitter end and the winding at the wireless power receiver end will precariously affect a power intensity of the wireless power receiver end, thus undesirably disturb an efficiency of wireless power transmission. As a result, in this case, typically and conventionally, the person skilled in this art determines whether the winding at the wireless power transmitter end is aligned with the winding at the wireless power receiver end according to a power intensity received by the wireless power receiver end. Such approach conducted by the person skilled in this art has following drawbacks that: the aforementioned approach is solely limited to being executed in a scenario where the wireless power transmitter end and the wireless power receiver end are designed as a pair of ends. Unfortunately and unwantedly, a general type wireless power transmitter end and a general type wireless power receiver end as shown in FIG. 1 have following drawbacks that: it is arduous to obtain an universal determination threshold for determining whether the general type wireless power transmitter end is aligned with the general type wireless power receiver end. For example, as exemplified by FIG. 1, a determination threshold Vth is solely limited to being adopted to determine whether the wireless power transmitter end is aligned with the wireless power receiver end A. Nevertheless, a major defect for the prior art shown in FIG. 1 lies in that: the prior art shown in FIG. 1 is incapable of determining whether the wireless power receiver end B is aligned with the wireless power transmitter end or whether the wireless power receiver end C is aligned with the wireless power transmitter end.

In view of the above, to overcome the drawbacks in the prior art, the present invention proposes a wireless power transmitter circuit, a transmission control circuit of such wireless power transmitter circuit and a transmission control method of such wireless power transmitter circuit, wherein the present invention has capacity to not only detect unwanted misalignment occurring between a wireless transmission winding and a wireless receiving winding, but also to instruct an user to adjust a position of the wireless power transmitter circuit and a position of the wireless power receiver circuit, hence executing alignment between the wireless transmission winding and the wireless receiving winding.

### SUMMARY OF THE INVENTION

From one perspective, the present invention provides a wireless power transmitter circuit, comprising: a power stage circuit including a plurality of switches, wherein the power stage circuit is coupled to a resonant transmitter circuit, wherein the resonant transmitter circuit includes: a transmission winding and a resonant capacitor, both of which are coupled to each other; and a transmission control circuit, which is configured to operably control the power stage circuit, wherein the transmission control circuit includes: a modulation circuit, which is configured to operably generate a pulse width modulation (PWM) control signal during a power supply procedure, so as to control the plural switches to convert a direct current (DC) power and generate a wireless transmission power at the resonant transmitter circuit, thereby supplying electrical power to a corresponding wireless power receiver circuit wirelessly; a storage unit, which is configured to operably store an authentication code-threshold database, wherein the authentication code-threshold database includes: at least one authentication code and at least one alignment intensity threshold corresponding to the at least one authentication code; and a communication circuit, which is configured to operably receive the at least one authentication code and a signal intensity value transmitted by the wireless power receiver circuit during a groping procedure, wherein during the groping procedure, the communication circuit is configured to operably read an alignment intensity threshold corresponding to the at least one authentication code from the storage unit, and wherein during the groping procedure, the communication circuit is configured to operably compare the signal intensity value with the alignment intensity threshold, so as to determine whether or not the wireless power transmitter circuit is aligned with the wireless power receiver circuit.

From another perspective, the present invention provides a transmission control circuit for use in a wireless power transmitter circuit, wherein the wireless power transmitter circuit includes: a power stage circuit including a plurality of switches, wherein the power stage circuit is coupled to a resonant transmitter circuit, wherein the resonant transmitter circuit includes: a transmission winding resonant capacitor, both of which are coupled to each other; wherein the transmission control circuit is configured to operably control the power stage circuit and the transmission control circuit includes: a modulation circuit, which is configured to operably generate a PWM control signal during a power supply procedure, so as to control the plural switches to convert a DC power and generate a wireless transmission power at the resonant transmitter circuit, thereby supplying electrical power to a corresponding wireless power receiver circuit wirelessly; wherein the transmission control circuit further comprises: a storage unit, which is configured to operably store an authentication code-threshold database, wherein the authentication code-threshold database includes: at least one authentication code and at least one alignment intensity threshold corresponding to the at least one authentication code; and a communication circuit, which is configured to operably receive the at least one authentication code and a signal intensity value transmitted by the wireless power receiver circuit during a groping procedure, wherein during the groping procedure, the communication circuit is configured to operably read an alignment intensity threshold corresponding to the at least one authentication code from the storage unit, and wherein during the groping procedure, the communication circuit is configured to operably compare the signal intensity value with the alignment intensity threshold, so as to determine whether or not the wireless power transmitter circuit is aligned with the wireless power receiver circuit.

From yet another perspective, the present invention provides a transmission control method for use in a wireless power transmitter circuit; the transmission control method comprising following steps: a power supply procedure: controlling the wireless power transmitter circuit to generate a wireless transmission power, thereby supplying electrical power to a corresponding wireless power receiver circuit wirelessly; and a groping procedure: receiving an authentication code and a signal intensity value transmitted by the wireless power receiver circuit, reading an alignment intensity threshold corresponding to the authentication code and comparing the signal intensity value with the alignment intensity threshold, so as to determine whether or not the wireless power transmitter circuit is aligned with the wireless power receiver circuit.

In one embodiment, the groping procedure further includes following steps: a digital groping step S10: the communication circuit is configured to operably control the power stage circuit to issue a digital groping package; an intensity package determination step S20: the communication circuit is configured to operably determine whether a signal intensity package is received, wherein when it is determined yes, proceeding to an authentication determination step S30 or otherwise proceeding back to the digital groping step S10; the authentication determination step S30: the communication circuit is configured to operably determine whether an authentication code package is received, wherein when it is determined yes, proceeding to an alignment determination step S40 or otherwise proceeding back to the digital groping step S10; and the alignment determination step S40: the communication circuit is configured to operably determine whether the wireless power transmitter circuit is aligned with the wireless power receiver circuit according to the alignment intensity threshold corresponding to the authentication code package and the signal intensity value corresponding to the signal intensity package.

In one embodiment, the groping procedure further includes following steps: an intensity stability determination step S21: subsequent to the intensity package determination step S20, the transmission control circuit is further configured to operably determine whether a preset numbers of or more than the preset numbers of signal the intensity packages are consecutively received, wherein the preset numbers are greater than or equal to two, wherein when it is determined yes, proceeding to the authentication determination step S30 or otherwise proceeding back to the digital groping step S10.

In one embodiment, the signal intensity value corresponding to the signal intensity package and configured to operably determine whether the wireless power transmitter circuit is aligned with the wireless power receiver circuit is an average value of a plurality of signal intensity values in the preset numbers of the signal intensity packages or the signal intensity value included in a last signal intensity package of the preset numbers of the signal intensity packages.

In one embodiment, when the alignment determination step S40 determines that the wireless power transmitter circuit is misaligned with the wireless power receiver circuit, the transmission control circuit is configured to operably issue a misalignment notification to the wireless power receiver circuit.

In one embodiment, the alignment determination step S40 further includes following steps: estimating a displacement value based upon a difference between the signal intensity value and the alignment intensity threshold; and issuing the displacement value to the wireless power receiver circuit.

In one embodiment, each of the at least one alignment intensity threshold and the at least one authentication code stored in the storage unit is updatable.

In one embodiment, the alignment intensity threshold corresponding to the authentication code which corresponds to the wireless power receiver circuit is generated or updated according to a plurality of position relationships between the wireless power transmitter circuit and the wireless power receiver circuit.

In one embodiment, the alignment determination step S40 further includes following steps: generating a plurality of differences between a plurality of corresponding signal intensity values and the corresponding alignment intensity threshold according to a plurality of position relationships between the wireless power transmitter circuit and the wireless power receiver circuit; and estimating the displacement value based upon the plurality of differences.

In one embodiment, the step for generating the plurality of differences includes following steps: instructing the wireless power receiver circuit to move along a straight direction or to move rotationally, so as to obtain the plurality of position relationships.

In one embodiment, the wireless power receiver circuit is further coupled to a display unit, and wherein the step for generating the plurality of differences includes following steps: controlling the wireless power receiver circuit to generate an image at the display unit by the wireless power transmitter circuit, so as to instruct an user to adjust a position of the wireless power receiver circuit, thus obtaining the plurality of position relationships.

In one embodiment, the groping procedure further includes following steps: a digital groping step S10: issuing a digital groping package; an intensity package determination step S20: determining whether a signal intensity package is received, wherein when it is determined yes, proceeding to an authentication determination step S30 or otherwise proceeding back to the digital groping step S10; the authentication determination step S30: determining whether an authentication code package is received, wherein when it is determined yes, proceeding to an alignment determination step S40 or otherwise proceeding back to the digital groping step S10; and the alignment determination step S40: determining whether the wireless power transmitter circuit is aligned with the wireless power receiver circuit according to the alignment intensity threshold corresponding to the authentication code package and the signal intensity value corresponding to the signal intensity package.

In one embodiment, subsequent to the intensity package determination step S20, the transmission control method further comprises following steps: an intensity stability determination step S21: further determining whether a preset numbers of or more than the preset numbers of the signal intensity packages are consecutively received, wherein the preset numbers are greater than or equal to two, wherein when it is determined yes, proceeding to the authentication determination step S30 or otherwise proceeding back to the digital groping step S10.

In one embodiment, when the alignment determination step S40 determines that the wireless power transmitter circuit is misaligned with the wireless power receiver circuit, a misalignment notification is issued to the wireless power receiver circuit.

In one embodiment, each of the alignment intensity threshold and the authentication code is updatable.

Advantages of the present invention include: that, the present invention has capacity to detect unwanted misalignment occurring between a wireless transmission winding and a wireless receiving winding; and that the present invention has capacity to instruct an user to adjust a position of the wireless transmission winding and a position of the wireless receiving winding, hence executing alignment between the wireless transmission winding and the wireless receiving winding.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a prior art characteristic curve depicting a signal intensity of a winding at a wireless power receiver end against an alignment offset between a winding at a wireless power transmitter end and the winding at the wireless power receiver end.

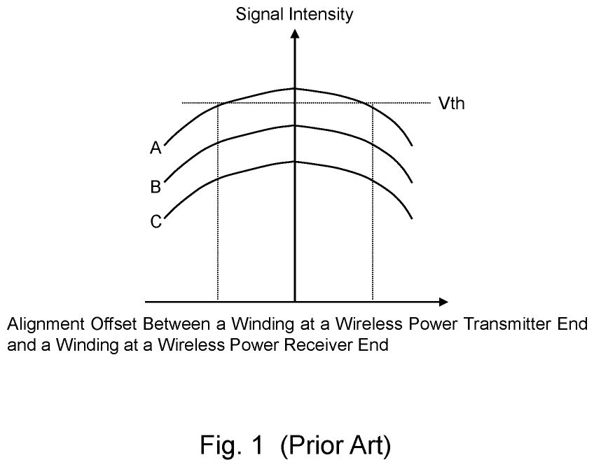

FIG. 2 shows a schematic circuit block diagram of a wireless power transmitter circuit according to an embodiment of the present invention.

FIG. 3 shows a schematic diagram of an authentication code-threshold database according to an embodiment of the present invention.

FIG. 4A illustrates a step flow chart of a transmission control method according to an embodiment of the present invention.

FIG. 4B illustrates a step flow chart of a transmission control method according to another embodiment of the present invention.

FIG. 5A illustrates a step flow chart of a transmission control method according to yet another embodiment of the present invention.

FIG. 5B illustrates a step flow chart of a transmission control method according to still another embodiment of the present invention.

FIG. 6 illustrates a step flow chart of a transmission control method according to still another embodiment of the present invention.

FIG. 7 shows a characteristic curve depicting a signal intensity of a winding at a wireless power receiver end against an alignment offset between a winding at a wireless power transmitter end and the winding at the wireless power receiver end according to an embodiment of the present invention.

FIG. 8 shows a schematic diagram demonstrating an offset occurring between a winding centre of a wireless power transmitter end and a winding centre of a wireless power receiver end according to an embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

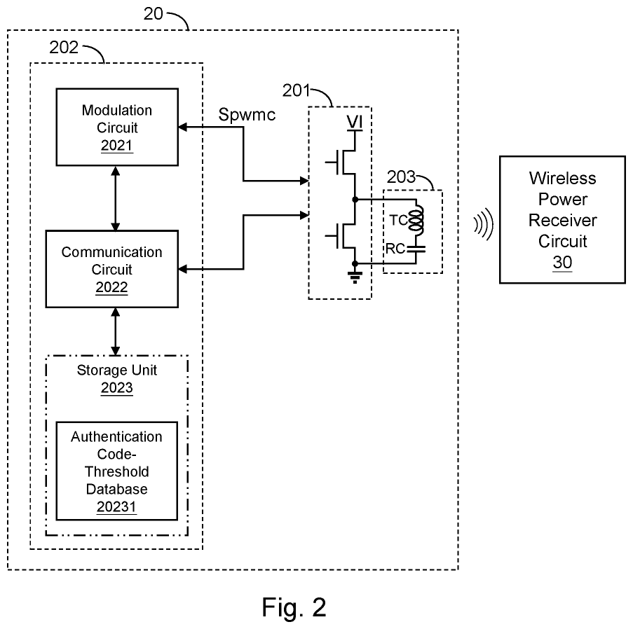

Please refer to FIG. 2, which shows a schematic circuit block diagram of a wireless power transmitter circuit according to an embodiment of the present invention. As shown in FIG. 2, in one embodiment, the wireless power transmitter circuit 20 comprises: a power stage circuit 201, a resonant transmitter circuit 203 and a transmission control circuit 202. In one embodiment, the power stage circuit 201 can be, for example, a half-bridge power stage circuit or a full-bridge power stage circuit. It should be understood that the implementation of the power stage circuit 201 shown in FIG. 2 as a half-bridge power stage circuit in the above-mentioned preferred embodiment is only an illustrative example, but not for limiting the broadest scope of the present invention. In other words, the half-bridge power stage circuit shown in FIG. 2 is an exemplary embodiment of the power stage circuit 201. The power stage circuit 201 includes plural switches, wherein the power stage circuit 201 is coupled to the resonant transmitter circuit 203. The resonant transmitter circuit 203 includes: a transmission winding TC (which can be regarded as an inductor) and a resonant capacitor RC, both of which are coupled to each other. The transmission control circuit 202 is configured to operably control the power stage circuit 201. The transmission control circuit 202 includes: a modulation circuit 2021, a storage unit 2023 and a communication circuit 2022. The modulation circuit 2021 is configured to operably generate a pulse width modulation (PWM) control signal Spwmc during a power supply procedure, so as to control the plural switches to convert a direct current (DC) power VI and generate a wireless transmission power at the resonant transmitter circuit 203, thereby supplying electrical power to a corresponding wireless power receiver circuit 30 wirelessly. The storage unit 2023 is configured to operably store an authentication code-threshold database 20231, wherein the authentication code-threshold database 20231 includes: at least one authentication code and at least one alignment intensity threshold corresponding to the at least one authentication code.

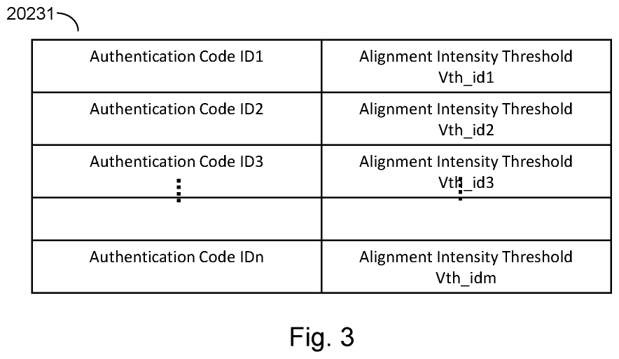

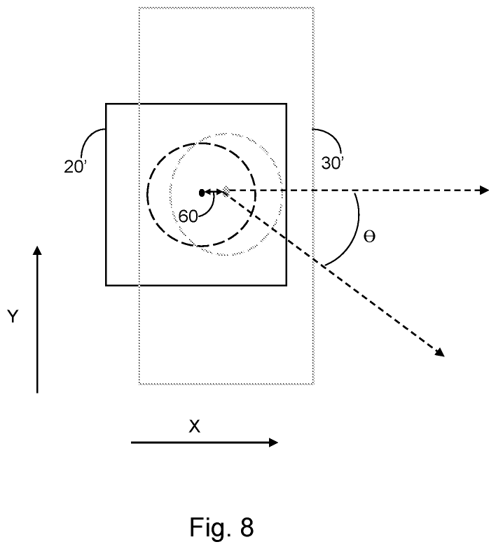

FIG. 3 shows a schematic diagram of an authentication code-threshold database according to an embodiment of the present invention. As shown in FIG. 3, the authentication code-threshold database 20231 includes: plural authentication codes ID1, ID2, ID3 . . . IDn and plural alignment intensity thresholds Vth_id1, Vth_id2, Vth_id3 . . . Vth_idm corresponding to the plural authentication codes ID1, ID2, ID3 . . . IDn, wherein each of n and m denotes a positive integer greater than one, and wherein n can be equal to m or n can be not equal to m. In one embodiment, n can be equal to or greater than m. That is, in one embodiment, the authentication code-threshold database 20231 can be regarded as a matching database where a set of one-to-one data in which one authentication code data corresponds to one alignment intensity threshold data stored in the authentication code-threshold database 20231. In alternative embodiment, the authentication code-threshold database 20231 can be regarded as a database where a set of several-to-one data in which several authentication codes data correspond to one alignment intensity threshold data stored in the authentication code-threshold database 20231. In one embodiment, each of the plural alignment intensity threshold Vth_id1, Vth_id2, Vth_id3 . . . Vth_idm and the plural authentication code ID1, ID2, ID3 . . . IDn stored in the storage unit 2023 is updatable. In one embodiment, the aforesaid alignment intensity thresholds Vth_id1, Vth_id2, Vth_id3 . . . Vth_idm and the aforesaid authentication codes ID1, ID2, ID3 . . . IDn can be updated through a firmware update approach. In another embodiment, the alignment intensity threshold corresponding to the authentication code which corresponds to the wireless power receiver circuit 30 is generated or updated according to plural position relationships between the wireless power transmitter circuit 20 and the wireless power receiver circuit 30. The communication circuit 2022 is configured to operably receive the authentication code (e.g., the authentication code ID2) and a signal intensity value transmitted by the wireless power receiver circuit 30 during a groping procedure. Moreover, during the groping procedure, the communication circuit 2022 is configured to operably read an alignment intensity threshold (e.g., an alignment intensity threshold Vth_id2) corresponding to the authentication code ID2 from the storage unit 2023. Furthermore, during the groping procedure, the communication circuit 2022 is configured to operably compare the signal intensity value with the alignment intensity threshold Vth_id2, so as to determine whether or not the wireless power transmitter circuit 20 is aligned with the wireless power receiver circuit 30. To be more specific, for example, the communication circuit 2022 is configured to operably compare the signal intensity value with the alignment intensity threshold Vth_id2, so as to determine whether or not a winding centre of a wireless power transmitter end is aligned with a winding centre of a wireless power receiver end (as shown in FIG. 8).

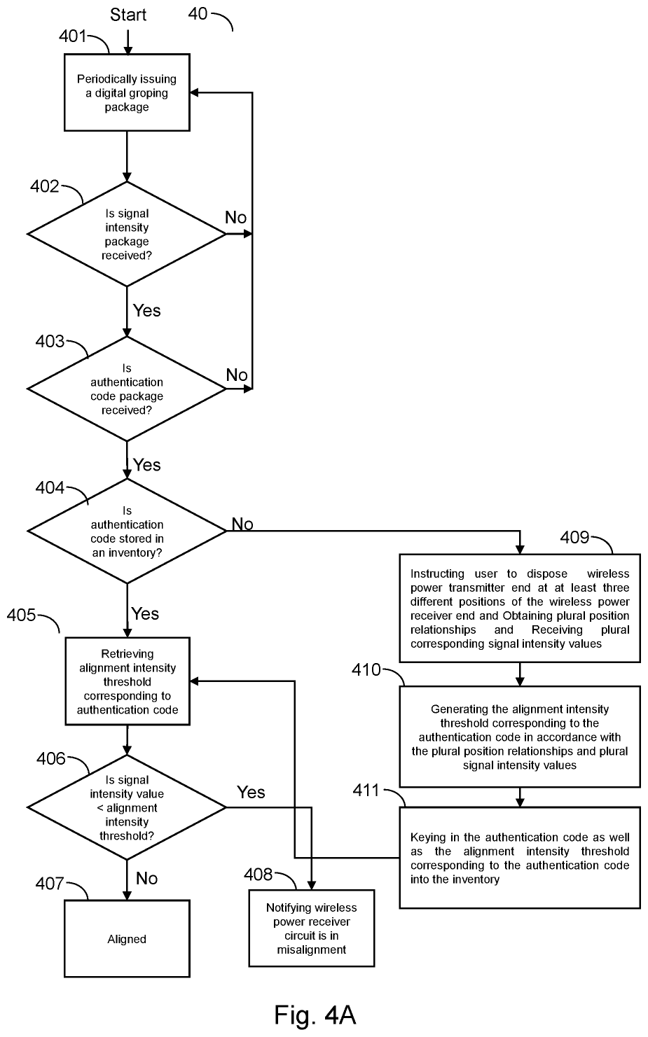

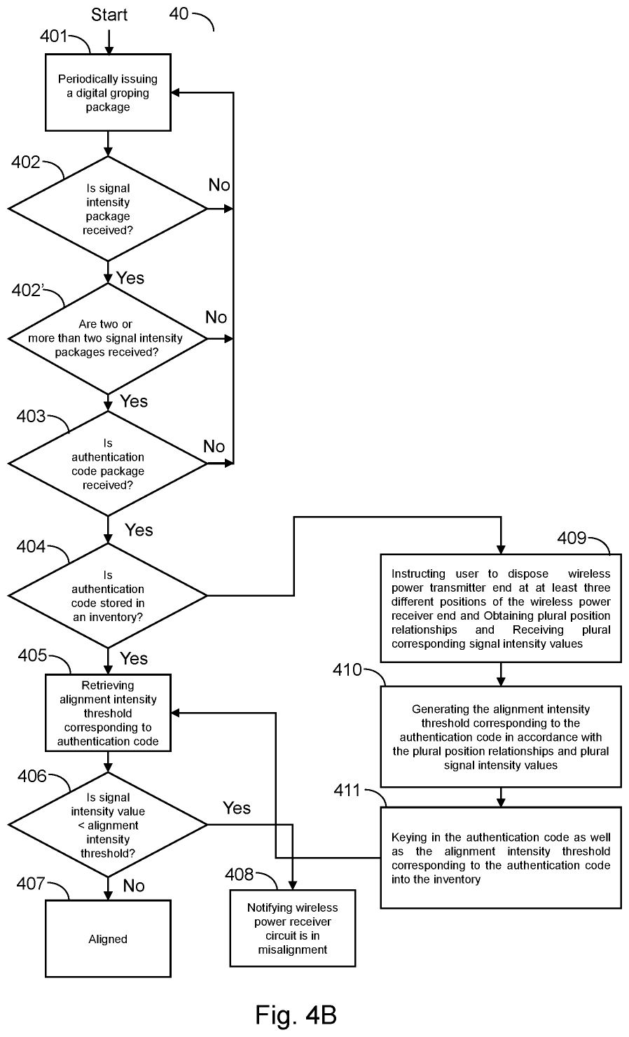

FIG. 4A illustrates a step flow chart of a transmission control method according to an embodiment of the present invention. Please refer to FIG. 4A along with FIG. 2. The above-mentioned groping procedure or a transmission control method 40 of the present invention includes following steps: in a step 401 (also referred as a digital groping step), the communication circuit 2022 is configured to operably control the power stage circuit 201 to periodically issue a digital groping package (e.g., the power stage circuit 201 will periodically issue a digital groping package at, for example but not limited to, every 0.5 second) complying with a preset communication specification, so as to ensure whether a corresponding wireless power receiver circuit 30 is in the presence. Subsequently, proceeding to a step 402 (also referred as an intensity package determination step), which includes: the communication circuit 2022 is configured to operably determine whether a signal intensity package is received from the wireless power receiver circuit 30. When it is determined that a result of the step 402 is yes (i.e., indicating that the wireless power receiver circuit 30 has already received the aforesaid digital groping package and the wireless power receiver circuit 30 has already transmitted the signal intensity package back to the wireless power transmitter circuit 20), proceeding to a step 403 or otherwise proceeding back to the step 401. Subsequently, proceeding to a step 403 (also referred as an authentication determination step), which includes: the communication circuit 2022 is configured to operably determine whether an authentication code package is received from the wireless power receiver circuit 30. When it is determined that a result of the step 403 is yes (i.e., indicating that the wireless power receiver circuit 30 has already received the aforesaid digital groping package and the wireless power receiver circuit 30 has already transmitted the authentication code package back to the wireless power transmitter circuit 20), proceeding to a step 404 or otherwise proceeding back to the step 401. It is noteworthy that, in this embodiment, the step 404, a step 405 and a step 406 are together referred as an alignment determination step, which includes: the communication circuit 2022 is configured to operably determine whether the wireless power transmitter circuit 20 is aligned with the wireless power receiver circuit 30 according to the alignment intensity threshold corresponding to the authentication code package and the signal intensity value corresponding to the signal intensity package. Nota that, the aforementioned that the wireless power transmitter circuit 20 is determined aligned with the wireless power receiver circuit 30, indicates that a wireless transmission winding of the wireless power transmitter circuit 20 is determined aligned with a wireless receiving winding of the wireless power receiver circuit 30.

In one embodiment, the step 404 includes: the communication circuit 2022 is configured to operably determine whether an authentication code corresponding to an authentication code package is stored in an inventory in an authentication code-threshold database in the storage unit 2023. When it is determined that a result of the step 404 is yes, proceeding to a step 405 or otherwise proceeding to a step 409. The step 405 includes: after the communication circuit 2022 has already retrieved the alignment intensity threshold corresponding to the authentication code from the storage unit 2023, proceeding to a step 406. The step 406 includes: the communication circuit 2022 is configured to operably determine whether the signal intensity value corresponding to the signal intensity package is smaller than the alignment intensity threshold retrieved from the storage unit 2023. When it is determined that a result of the step 406 is yes (i.e., indicating that the wireless power transmitter circuit 20 is misaligned with the wireless power receiver circuit 30), proceeding to a step 408 or otherwise proceeding to a step 407. The step 407 includes: the communication circuit 2022 is configured to operably determine that the wireless power transmitter circuit 20 is aligned with the wireless power receiver circuit 30. As a result, in this case, the wireless power transmitter circuit 20 can for example keep supplying the wireless power to the wireless power receiver circuit 30.

In one embodiment, the step 408 includes: the communication circuit 2022 is configured to operably determine that the wireless power transmitter circuit 20 is misaligned with the wireless power receiver circuit 30. In one embodiment, when the step 408 determines that the wireless power transmitter circuit 20 is misaligned with the wireless power receiver circuit 30, the communication circuit 2022 in the transmission control circuit 202 is configured to operably and optionally issue a misalignment notification to the wireless power receiver circuit 30, thereby notifying an user to properly adjust a position of the wireless power transmitter circuit 20 with respect to a position of the wireless power receiver circuit 30. The step 409 includes: controlling the wireless power receiver circuit 30 to generate an image at for example a display unit by the wireless power transmitter circuit 20, so as to instruct an user to adjust a position of the wireless power receiver circuit 30 with respect to a position of the wireless power transmitter circuit 20 (e.g., adjusting at least three different positions) through instructing the wireless power receiver circuit 30 to move along a straight direction or to move rotationally, thus obtaining the plural position relationships and receiving plural signal intensity values corresponding to the plural position relationships. The aforementioned display unit is coupled to the wireless power receiver circuit 30. The step 410 includes: the communication circuit 2022 is configured to operably generate the alignment intensity threshold corresponding to the authentication code in accordance with the plural position relationships and plural signal intensity values. The step 411 includes: the storage unit 2023 is configured to operably key in the authentication code as well as the alignment intensity threshold corresponding to the authentication code into the inventory in the authentication code-threshold database 20231. Subsequently, proceeding back to the step 405.

FIG. 4B illustrates a step flow chart of a transmission control method according to another embodiment of the present invention. The transmission control method 40 of this embodiment shown in FIG. 4B is similar to the transmission control method 40 of the embodiment shown in FIG. 4A, but is different in that: as compared to the transmission control method 40 of the embodiment shown in FIG. 4A, the transmission control method 40 of this embodiment shown in FIG. 4B includes an extra step 402′ (also referred as an intensity stability determination step). The step 402′ includes: the transmission control circuit 202 is further configured to operably determine whether a preset numbers of or more than the preset numbers of the signal intensity packages are consecutively received. When it is determined that a result of the step 402′ is yes, proceeding to a step 403 or otherwise proceeding back to a step 401. In one embodiment, the aforementioned preset numbers are greater than or equal to two. In one embodiment, the signal intensity value which corresponds to the signal intensity package and which is configured to operably determine whether the wireless power transmitter circuit 20 is aligned with the wireless power receiver circuit 30 is an average value of plural signal intensity values in the preset numbers of the signal intensity packages or the signal intensity value included in a last signal intensity package of the preset numbers of the signal intensity packages.

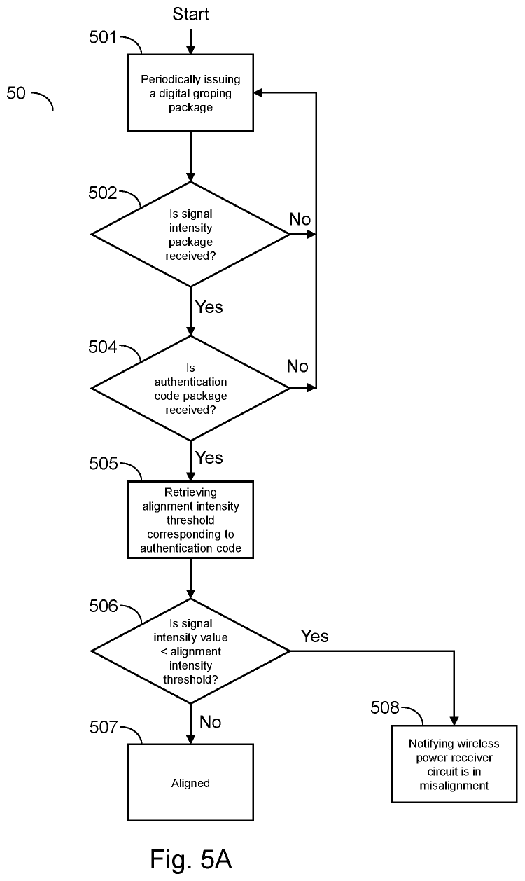

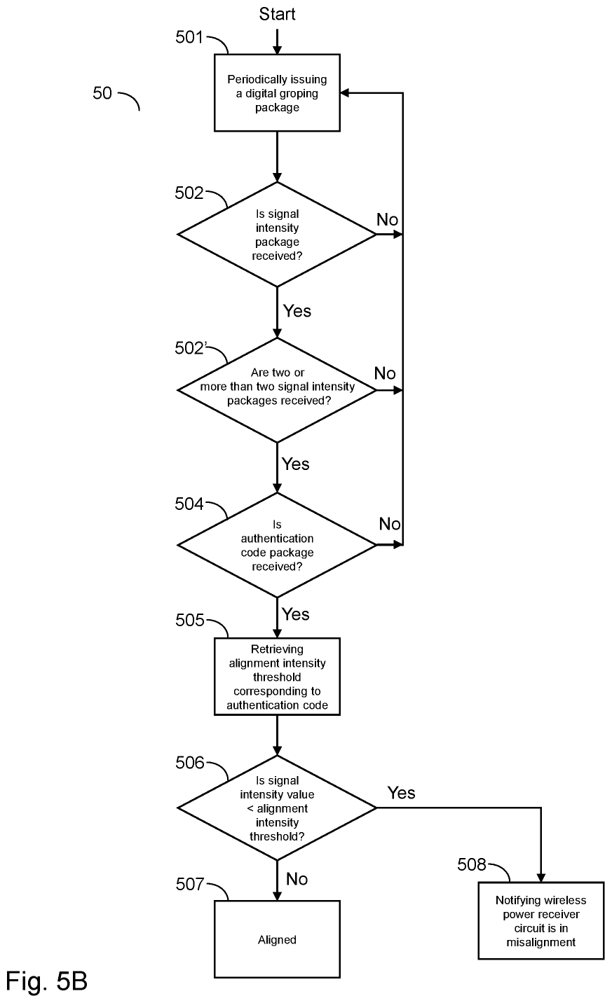

FIG. 5A illustrates a step flow chart of a transmission control method according to yet another embodiment of the present invention. Steps 501˜502 and steps 504˜508 of this embodiment shown in FIG. 5A are similar to the steps 401˜403 and the steps 405˜408 of the embodiment shown in FIG. 4A, but is different in that: the step 404 and the steps 409˜411 of the embodiment shown in FIG. 4A can be omitted from this embodiment shown in FIG. 5A.

FIG. 5B illustrates a step flow chart of a transmission control method according to still another embodiment of the present invention. Steps 501˜502′ and steps 504˜508 of this embodiment shown in FIG. 5B are similar to the steps 401˜403 and the steps 405˜408 of the embodiment shown in FIG. 4B, but is different in that: the step 404 and the steps 409˜411 of the embodiment shown in FIG. 4B can be omitted from this embodiment shown in FIG. 5B.

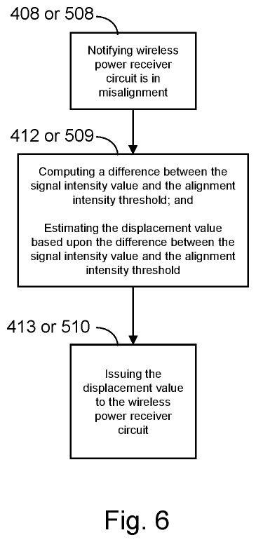

FIG. 6 illustrates a step flow chart of a transmission control method according to still another embodiment of the present invention. In one embodiment, subsequent to the step 408 shown in FIG. 4A or the step 508 shown in FIG. 5A, the transmission control method of this embodiment further includes steps 412 and 413 shown in FIG. 4A, or, the transmission control method of this embodiment further includes steps 509 and 510 shown in FIG. 5A. Please refer to FIG. 6 along with FIG. 2. The step 412 or the step 509 includes: the communication circuit 2022 is configured to operably compute a difference between the signal intensity value and the alignment intensity threshold. And, the communication circuit 2022 is configured to operably estimating the displacement value based upon the difference between the signal intensity value and the alignment intensity threshold. Subsequently, proceeding to the step 413 or the step 510, which includes: the communication circuit 2022 is configured to operably issue the displacement value to the wireless power receiver circuit 30, hence notifying a user to properly adjust a position of the wireless power transmitter circuit 20 with respect to a position of the wireless power receiver circuit 30. In another embodiment, the displacement value can be estimated according to plural differences (between plural signal intensity values and the alignment intensity threshold). To elaborate in detail, for example, generating plural differences between plural corresponding signal intensity values and the corresponding alignment intensity threshold according to plural position relationships between the wireless power transmitter circuit 20 and the wireless power receiver circuit 30. Subsequently, estimating the displacement value based upon the plural differences.

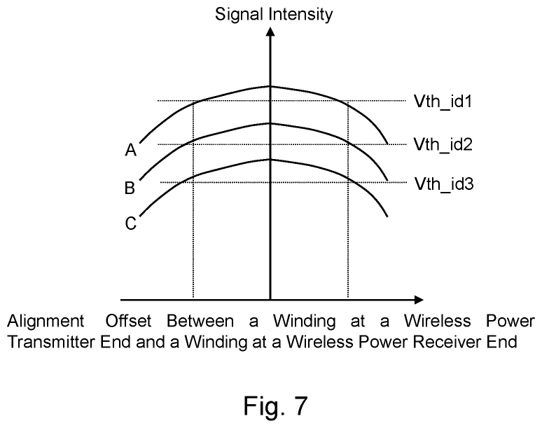

FIG. 7 shows a characteristic curve depicting a signal intensity of a winding at a wireless power receiver end against an alignment offset between a winding at a wireless power transmitter end and the winding at the wireless power receiver end according to an embodiment of the present invention. As shown in FIG. 7, in a case where an alignment offset between a winding at a wireless power transmitter end and the winding at the wireless power receiver end is zero (i.e., the wireless power transmitter end is aligned with the wireless power receiver end), a signal intensity of the winding at the wireless power receiver end is most intense. Note that, the present invention is capable of estimating a displacement value based upon the characteristic curve depicting the signal intensity of the winding at the wireless power receiver end against the alignment offset between the winding at the wireless power transmitter end and the winding at the wireless power receiver end shown in FIG. 7 and the resultant difference between the signal intensity value and the alignment intensity threshold obtained via computation in the step 412 or the step 509.

FIG. 8 shows a schematic diagram demonstrating an offset occurring between a winding centre of a wireless power transmitter end and a winding centre of a wireless power receiver end according to an embodiment of the present invention. As shown in FIG. 8, a grey rectangular frame denotes a wireless power receiver end 30′, whereas, a block rectangular frame denotes a wireless power transmitter end 20′. In addition, a grey dotted line circle denotes a wireless receiving winding in the wireless power receiver end 30′, whereas, a block dotted line circle denotes a wireless transmission winding in the wireless power transmitter end 20′. Moreover, a grey ellipse point denotes a centre of the wireless receiving winding in the wireless power receiver end 30′, whereas, a block ellipse point denotes a centre of the wireless transmission winding in the wireless power transmitter end 20′. As shown in FIG. 8, a double arrow denotes an offset occurring between the centre of the wireless receiving winding in the wireless power receiver end 30′ and the block ellipse point denotes a centre of the wireless transmission winding in the wireless power transmitter end 20′ is equal to 60. In one embodiment, the above-mentioned vertical coordinate axis corresponds to for example a X-direction or a Y-direction shown in FIG. 8, whereas, the above-mentioned rotational coordinate axis corresponds to for example θ shown in FIG. 8.

As elaborated above, the wireless power transmitter circuit of the present invention has capacity to not only detect unwanted misalignment occurring between a wireless transmission winding (wireless power transmitter circuit) and a wireless receiving winding (wireless power receiver circuit), but also to instruct a user to adjust a position of the wireless transmission winding (wireless power transmitter circuit) and a position of the wireless receiving winding (wireless power receiver circuit), hence executing alignment between the wireless transmission winding and the wireless receiving winding.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A wireless power transmitter circuit, comprising:
a power stage circuit including a plurality of switches, wherein the power stage circuit is coupled to a resonant transmitter circuit, wherein the resonant transmitter circuit includes: a transmission winding and a resonant capacitor, both of which are coupled to each other; and
a transmission control circuit, which is configured to operably control the power stage circuit, wherein the transmission control circuit includes:
a modulation circuit, which is configured to operably generate a pulse width modulation (PWM) control signal during a power supply procedure, so as to control the plural switches to convert a direct current (DC) power and generate a wireless transmission power at the resonant transmitter circuit, thereby electrical power to supplying a corresponding wireless power receiver circuit wirelessly;
a storage unit, which is configured to operably store an authentication code-threshold database, wherein the authentication code-threshold database includes: at least one authentication code and at least one alignment intensity threshold corresponding to the at least one authentication code; and
a communication circuit, which is configured to operably receive the at least one authentication code and a signal intensity value transmitted by the wireless power receiver circuit during a groping procedure, wherein during the groping procedure, the communication circuit is configured to operably read an alignment intensity threshold corresponding to the at least one authentication code from the storage unit, and wherein during the groping procedure, the communication circuit is configured to operably compare the signal intensity value with the alignment intensity threshold, so as to determine whether or not the wireless power transmitter circuit is aligned with the wireless power receiver circuit.

2. The wireless power transmitter circuit of claim 1, wherein the groping procedure further includes following steps:
a digital groping step S10: the communication circuit is configured to operably control the power stage circuit to issue a digital groping package;
an intensity package determination step S20: the communication circuit is configured to operably determine whether a signal intensity package is received, wherein when it is determined yes, proceeding to an authentication determination step S30 or otherwise proceeding back to the digital groping step S10;
the authentication determination step S30: the communication circuit is configured to operably determine whether an authentication code package is received, wherein when it is determined yes, proceeding to an alignment determination step S40 or otherwise proceeding back to the digital groping step S10; and
the alignment determination step S40: the communication circuit is configured to operably determine whether the wireless power transmitter circuit is aligned with the wireless power receiver circuit according to the alignment intensity threshold corresponding to the authentication code package and the signal intensity value corresponding to the signal intensity package.

3. The wireless power transmitter circuit of claim 2, wherein the groping procedure further includes following steps:
an intensity stability determination step S21: subsequent to the intensity package determination step S20, the transmission control circuit is further configured to operably determine whether a preset numbers of or more than the preset numbers of the signal intensity packages are consecutively received, wherein the preset numbers are greater than or equal to two, wherein when it is determined yes, proceeding to the authentication determination step S30 or otherwise proceeding back to the digital groping step S10.

4. The wireless power transmitter circuit of claim 3, wherein the signal intensity value corresponding to the signal intensity package and configured to operably determine whether the wireless power transmitter circuit is aligned with the wireless power receiver circuit is an average value of a plurality of signal intensity values in the preset numbers of the signal intensity packages or the signal intensity value included in a last signal intensity package of the preset numbers of the signal intensity packages.

5. The wireless power transmitter circuit of claim 2, wherein when the alignment determination step S40 determines that the wireless power transmitter circuit is misaligned with the wireless power receiver circuit, the transmission control circuit is configured to operably issue a misalignment notification to the wireless power receiver circuit.

6. The wireless power transmitter circuit of claim 2, wherein the alignment determination step S40 further includes following steps:
estimating a displacement value based upon a difference between the signal intensity value and the alignment intensity threshold; and
issuing the displacement value to the wireless power receiver circuit.

7. The wireless power transmitter circuit of claim 1, wherein each of the at least one alignment intensity threshold and the at least one authentication code stored in the storage unit is updatable.

8. The wireless power transmitter circuit of claim 1, wherein the alignment intensity threshold corresponding to the authentication code which corresponds to the wireless power receiver circuit is generated or updated according to a plurality of position relationships between the wireless power transmitter circuit and the wireless power receiver circuit.

9. The wireless power transmitter circuit of claim 6, wherein the alignment determination step S40 further includes following steps:
generating a plurality of differences between a plurality of corresponding signal intensity values and the corresponding alignment intensity threshold according to a plurality of position relationships between the wireless power transmitter circuit and the wireless power receiver circuit; and
estimating the displacement value based upon the plurality of differences.

10. The wireless power transmitter circuit of claim 9, wherein the step for generating the plurality of differences includes following steps:
instructing the wireless power receiver circuit to move along a straight direction or to move rotationally, so as to obtain the plurality of position relationships.

11. The wireless power transmitter circuit of claim 9, wherein the wireless power receiver circuit is further coupled to a display unit, and wherein the step for generating the plurality of differences includes following steps:
controlling the wireless power receiver circuit to generate an image at the display unit by the wireless power transmitter circuit, so as to instruct an user to adjust a position of the wireless power receiver circuit, thus obtaining the plurality of position relationships.

12. A transmission control circuit for use in a wireless power transmitter circuit, wherein the wireless power transmitter circuit includes: a power stage circuit including a plurality of switches, wherein the power stage circuit is coupled to a resonant transmitter circuit, wherein the resonant transmitter circuit includes: a transmission winding and a resonant capacitor, both of which are coupled to each other; wherein the transmission control circuit is configured to operably control the power stage circuit and the transmission control circuit includes: a modulation circuit, which is configured to operably generate a PWM control signal during a power supply procedure, so as to control the plural switches to convert a DC power and generate a wireless transmission power at the resonant transmitter circuit, thereby supplying electrical power to a corresponding wireless power receiver circuit wirelessly; wherein the transmission control circuit further comprises:
a storage unit, which is configured to operably store an authentication database, wherein code-threshold the authentication code-threshold database includes: at least one authentication code and at least one alignment intensity threshold corresponding to the at least one authentication code; and
a communication circuit, which is configured to operably receive the at least one authentication code and a signal intensity value transmitted by the wireless power receiver circuit during a groping procedure, wherein during the groping procedure, the communication circuit is configured to operably read an alignment intensity threshold corresponding to the at least one authentication code from the storage unit, and wherein during the groping procedure, the communication circuit is configured to operably compare the signal intensity value with the alignment intensity threshold, so as to determine whether or not the wireless power transmitter circuit is aligned with the wireless power receiver circuit.

13. The transmission control circuit of claim 12, wherein the groping procedure further includes following steps:
a digital groping step S10: the communication circuit is configured to operably control the power stage circuit to issue a digital groping package;
an intensity package determination step S20: the communication circuit is configured to operably determine whether a signal intensity package is received, wherein when it is determined yes, proceeding to an authentication determination step S30 or otherwise proceeding back to the digital groping step S10;
the authentication determination step S30: the communication circuit is configured to operably determine whether an authentication code package is received, wherein when it is determined yes, proceeding to an alignment determination step S40 or otherwise proceeding back to the digital groping step S10; and
the alignment determination step S40: the communication circuit is configured to operably determine whether the wireless power transmitter circuit is aligned with the wireless power receiver circuit according to the alignment intensity threshold corresponding to the authentication code package and the signal intensity value corresponding to the signal intensity package.

14. The transmission control circuit of claim 13, wherein the groping procedure further includes following steps:
an intensity stability determination step S21: subsequent to the intensity package determination step S20, the transmission control circuit is further configured to operably determine whether a preset numbers of or more than the preset numbers of the signal intensity packages are consecutively received, wherein the preset numbers are greater than or equal to two, wherein when it is determined yes, proceeding to the authentication determination step S30 or otherwise proceeding back to the digital groping step S10.

15. The transmission control circuit of claim 14, wherein the signal intensity value corresponding to the signal intensity package and configured to operably determine whether the wireless power transmitter circuit is aligned with the wireless power receiver circuit is an average value of a plurality of signal intensity values in the preset numbers of the signal intensity packages or the signal intensity value included in a last signal intensity package of the preset numbers of the signal intensity packages.

16. The transmission control circuit of claim 13, wherein when the alignment determination step S40 determines that the wireless power transmitter circuit is misaligned with the wireless power receiver circuit, the transmission control circuit is configured to operably issue a misalignment notification to the wireless power receiver circuit.

17. The transmission control circuit of claim 13, wherein the alignment determination step S40 further includes following steps:
estimating a displacement value based upon a difference between the signal intensity value and the alignment intensity threshold; and
issuing the displacement value to the wireless power receiver circuit.

18. The transmission control circuit of claim 12, wherein each of the at least one alignment intensity threshold and the at least one authentication code stored in the storage unit is updatable.

19. The transmission control circuit of claim 12, wherein the alignment intensity threshold corresponding to the authentication code which corresponds to the wireless power receiver circuit is generated or updated according to a plurality of position relationships between the wireless power transmitter circuit and the wireless power receiver circuit.

20. The transmission control circuit of claim 17, wherein the alignment determination step S40 further includes following steps:
generating a plurality of differences between a plurality of corresponding signal intensity values and the corresponding alignment intensity threshold according to a plurality of position relationships between the wireless power transmitter circuit and the wireless power receiver circuit; and
estimating the displacement value based upon the plurality of differences.

21. A transmission control method for use in a wireless power transmitter circuit; the transmission control method comprising following steps:
a power supply procedure: controlling the wireless power transmitter circuit to generate a wireless transmission power, thereby supplying electrical power to a corresponding wireless power receiver circuit wirelessly; and
a groping procedure: receiving an authentication code and a signal intensity value transmitted by the wireless power receiver circuit, reading an alignment intensity threshold corresponding to the authentication code and comparing the signal intensity value with the alignment intensity threshold, so as to determine whether or not the wireless power transmitter circuit is aligned with the wireless power receiver circuit.

22. The transmission control method of claim 21, wherein the groping procedure further includes following steps:
a digital groping step S10: issuing a digital groping package;
an intensity package determination step S20: determining whether a signal intensity package is received, wherein when it is determined yes, proceeding to an authentication determination step S30 or otherwise proceeding back to the digital groping step S10;
the authentication determination step S30: determining whether an authentication code package is received, wherein when it is determined yes, proceeding to an alignment determination step S40 or otherwise proceeding back to the digital groping step S10; and
the alignment determination step S40: determining whether the wireless power transmitter circuit is aligned with the wireless power receiver circuit according to the alignment intensity threshold corresponding to the authentication code package and the signal intensity value corresponding to the signal intensity package.

23. The transmission control method of claim 22, wherein subsequent to the intensity package determination step S20, the transmission control method further comprises following steps:
an intensity stability determination step S21: further determining whether a preset numbers of or more than the preset numbers of the signal intensity packages are consecutively received, wherein the preset numbers are greater than or equal to two, wherein when it is determined yes, proceeding to the authentication determination step S30 or otherwise proceeding back to the digital groping step S10.

24. The transmission control method of claim 23, wherein the signal intensity value corresponding to the signal intensity package and configured to operably determine whether the wireless power transmitter circuit is aligned with the wireless power receiver circuit is an average value of a plurality of signal intensity values in the preset numbers of the signal intensity packages or the signal intensity value included in a last signal intensity package of the preset numbers of the signal intensity packages.

25. The transmission control method of claim 22, wherein when the alignment determination step S40 determines that the wireless power transmitter circuit is misaligned with the wireless power receiver circuit, a misalignment notification is issued to the wireless power receiver circuit.

26. The transmission control method of claim 22, wherein the alignment determination step S40 further includes following steps:
estimating a displacement value based upon a difference between the signal intensity value and the alignment intensity threshold; and
issuing the displacement value to the wireless power receiver circuit.

27. The transmission control method of claim 21, wherein each of the at least one alignment intensity threshold and the at least one authentication code stored in the storage unit is updatable.

28. The transmission control method of claim 21, wherein the alignment intensity threshold to the corresponding authentication code which corresponds to the wireless power receiver circuit is generated or updated according to a plurality of position relationships between the wireless power transmitter circuit and the wireless power receiver circuit.

29. The transmission control method of claim 26, wherein the alignment determination step S40 further includes following steps:
generating a plurality of differences between a plurality of corresponding signal intensity values and the corresponding alignment threshold according to a plurality of position relationships between the wireless power transmitter circuit and the wireless power receiver circuit; and
estimating the displacement value based upon the plurality of differences.
